(19) United States
(12) Patent Application Publication
(10) Pub. No.: US 2007/0252488 A1
(43) Pub. Date: Nov. 1, 2007

(54) Vehicle alternator

(75) Inventors: Shin Kusase, Oobu-shi (JP); Yuya Mizuma, Gamagoori-shi (JP)

Correspondence Address: OLIFF & BERRIDGE, PLC, P.O. BOX 19928, ALEXANDRIA, VA, 22320, US

(73) Assignee: DENSO CORPORATION, KARIYA-CITY (JP)

(21) Appl. No.: 11/703,170

(22) Filed: Feb. 7, 2007

(30) Foreign Application Priority Data
Apr. 27, 2006 (JP) 2006-124125

(51) Int. Cl. H02K 5/04; H02K 11/04

(52) U.S. Cl. 310/68 D

(57) ABSTRACT

A vehicle alternator is disclosed including a metallic frame supporting a stator having an armature winding and a rotor having a field winding. A rectifying unit is fixedly mounted on the frame for rectifying an alternating current voltage induced in the armature winding upon rotation of the rotor and comprises a stack of a positive-electrode radiating fin, carrying thereon a positive-electrode rectifier element, and a negative-electrode radiating fin, carrying thereon a negative-electrode rectifier element, between which a heat conducting sheet having insulation property is intervened. The frame carries thereon an insulating cover for covering the rectifying unit. The cover includes an encompassing section that collectively encompasses the positive-electrode rectifier element and an associated neighborhood to prevent the cooling wind drawn to an inside of the cover due to rotation of the cooling fan from directly impinging upon the positive-electrode rectifier element.

### CROSS REFERENCE TO RELATED APPLICATIONS

This application is based on Japanese Patent Application Nos. 2006-124125, filed on Apr. 27, 2006, the content of which is hereby incorporated by reference.

### BACKGROUND OF THE INVENTION

1. Technical Field of the Invention

The present invention relates to vehicle alternators and, more particularly, to a vehicle alternator arranged to generate a high voltage at, for instance, 42V

2. Description of the Related Art

In recent years, there have been increasing trends in the number of and kinds of electric components, having increased power consumptions, which are installed on motor vehicles. Further, the motor vehicles have increasingly employed electric components operating at high power rates for obtaining growing safeties and conveniences. Thus, a need arises for a vehicle alternator (hereinafter also referred to as an alternator) to provide a high power output. However, the alternator rating at 12V, widely used in the related art to meet these requirements, and is thus in a difficult situation. Therefore, there is an increasing demand for a highly efficient alternator to be provided for generating a high voltage of, for instance, 42V. In addition, with a view to complying with such an increase in the number of various equipment and requirements for ensuring an increased living space in a vehicle compartment, an engine room has been narrowed in space and it has been an important task to miniaturize the alternator.

Meanwhile, with the development of alternators in miniaturized structures rated at high power outputs, rectifying units and electric power generating coils tend to operate at high temperatures and it becomes more important for these heat generating components to be cooled in high frequencies. Among these heat generating components, the electric power generating coil, located in an area radially outward of a cooling fan, can be efficiently cooled with a cooling wind discharged from the cooling fan even though the electric power generation coil has the greatest heat value among the other component parts of the alternator. In contrast, the rectifying unit employs semiconductor elements (such as diodes) that are extremely delicate to the operating temperatures.

Thus, it is difficult to locate the semiconductor elements in an area in the vicinity of the power generating coil operating at high temperatures. Therefore, a difficulty is encountered in compelling the cooling wind, generated by the cooling fan, to be directly blown off to the semiconductor elements for cooling. Therefore, it has been a usual practice for the rectifying unit to be located in a ventilation path, through which the cooling fan draws an air stream as a cooling wind, to cause the cooling wind, flowing at a gradual speed, to cool the semiconductor elements.

However, in a case where the operating temperature of the rectifying unit operates increases due to the operation of the alternator miniaturized in structure and operating at a high power rate, the flow of cooling wind passing at a slow speed has been inadequate to efficiently cool the semiconductor elements. To address such an issue, an attempt has heretofore been made to provide an alternator formed in a structure as disclosed in Japanese Unexamined Patent Application Publication No. 4-244770.

With such an alternator, a negative-electrode cooling fan carries thereon a negative-electrode rectifier element and is held in abutting contact with a rear end frame. Meanwhile, a positive-electrode cooling fan carries thereon a positive-electrode rectifier element and is held in abutting contact with a metallic end cover. The cooling fins are axially spaced from each other by a given distance to provide an axial clearance serving as a ventilation flow path to admit the flow of a cooling wind created by a cooling fan.

With such a structure, even though the cooling wind flows at a slow speed, the rectifying unit is cooled to a low temperature to some extents with the aid of heat conducting effect.

However, with the alternator of such a related art structure, a ventilation flow path is formed upon providing an increased axial clearance between the associated cooling fins, resulting in an increase in an axial length of the alternator with impediments to the miniaturization of the alternator.

Further, the cooling wind is mostly caused to flow through the ventilation flow 10 path defined between both the cooling fins. Therefore, if a cooling wind mixed with salt water flows through such a ventilation flow path, corrosion takes place on the positive-electrode rectifier element and wirings due to salt water. Especially with the alternator rated at a high output voltage such as 42V, corrosion of the positive-electrode rectifier element, exposed to the ventilation flow path, are further accelerated.

In addition, since the positive-electrode cooling fin remaining with a given voltage potential is held in abutting contact with the metallic end cover, risks will occur for a leakage current to flow through the end cover from the positive-electrode cooling fin remaining with the given voltage potential, causing a difficulty in achieving practical realization.

### SUMMARY OF THE INVENTION

The present invention has been completed with a view to addressing the above issues and has an object to provide a vehicle alternator that is reduced in axial dimension to form a miniaturized structure yet having improved cooling capability of a rectifying unit while having capability of protecting a positive-electrode rectifier element in a highly reliable fashion.

To achieve the above object, one aspect of the present invention provides a vehicle alternator comprising a stator having an armature winding, a rotor having a field winding, and a metallic frame supporting the stator and the rotor. A rectifying unit is placed on the frame at an outside area thereof and rectifying an alternating current voltage induced in the armature winding upon rotation of the rotor, which comprises a positive-electrode rectifier element, a negative-electrode rectifier element, a positive-electrode radiating fin, carrying thereon the positive-electrode rectifier element, and a negative-electrode radiating fin carrying thereon the negative-electrode rectifier element. An insulating cover is provided with which the rectifying unit is covered. The positive-electrode radiating fin and the negative-electrode radiating fin are axially placed adjacent to each other between the rear frame and the cover.

With such a structure of the vehicle alternator, since the negative-electrode radiating fin and the positive-electrode radiating fin are axially placed adjacent to is each other between the rear frame and the cover, the vehicle alternator is formed in a miniaturized structure with a shortened axial length yet providing highly improved cooling performance of the rectifying unit. Further, since the negative-electrode radiating fin is held in contact with the frame and the negative-electrode radiating fin and the positive-electrode radiating fin are axially placed adjacent to each other, improved the heat conducting path is established between the negative-electrode radiating fin and the positive-electrode radiating fin. This allows the rectifying unit to radiate heat to the frame and the cover, providing improved cooling capability

In addition, the presence of the negative-electrode radiating fin and the positive-electrode radiating fin axially placed adjacent to each other enables a reduction in an axial dimension of the vehicle alternator, making it possible to form the vehicle alternator in a miniaturized construction.

With the vehicle alternator of the present embodiment, the negative-electrode radiating fin and the positive-electrode radiating fin may be stacked on each other via a heat conducting sheet having insulation property.

With such a structure, uniform temperature distribution is achieved in the rectifying unit and improved heating radiating performance can be achieved between the negative-electrode radiating fin and the positive-electrode radiating fin, resulting in increased cooling performance of the rectifying unit.

With the vehicle alternator of the present embodiment, the negative-electrode radiating fin may be fixedly secured to the frame in contact therewith.

With such a structure, since the negative-electrode radiating fin is held in direct contact with the metallic frame, heat developed in the negative-electrode radiating fin is transferred to the metallic frame with which heat is radiated due to the cooling wind created by the cooling fan upon rotation thereof.

With the vehicle alternator of the present embodiment, the positive-electrode radiating fin may be held in direct contact with the cover.

With such a structure, the cooling ability can be improved, where heat developed in the positive-electrode radiating fin can be delivered to the cover through which heat can be radiated.

With the vehicle alternator of the present embodiment, the cover may be held in contact with the positive-electrode radiating fin via a heat conducting sheet having high heat conductivity.

The heat conducting sheet allows heat to be transferred from the positive-electrode radiating fin to the cover, resulting in improved cooling performance of the rectifying unit.

With the vehicle alternator of the present embodiment, the cover may have an outer circumferential periphery formed with heat radiating fins.

The presence of the heat radiating fins formed on the outer circumferential periphery of the cover enables heat, transferred from the rectifying unit to the cover, to be effectively radiated to the atmosphere, resulting in further improved heat radiating capability. This allows the rectifying unit to have increased heat radiating performance.

With the vehicle alternator of the present embodiment, the cover may be formed with air inlet openings for drawing air streams to an inside of the cover due to rotation of the cooling fan, and wherein the positive-electrode radiating fin may have an inner periphery formed with at least one protrusion radially extending inward and exposed to the air inlet openings.

With such a structure, the positive-electrode radiating fin can be cooled with the air stream flowing through the air inlet opening, resulting in improved cooling performance of the rectifying unit.

With the vehicle alternator of the present embodiment, the air inlet openings may be formed in the cover in radiated configurations, and the cover may include a plurality of radially extending partition walls each of which partitions the air inlet openings which are adjacent to each other in a circumferential direction and each of which is inclined with respect to a center of axis.

Since the partition walls are inclined with respect to a central axis of the cover, the air inlet openings have effects of suppressing the entry of foreign materials from the air inlet openings. Further, the partition walls have increased surface areas and have the effects of radiating fins.

With the vehicle alternator of the present embodiment, the frame may include a circumferentially extending dike wall, having an axial end face with which the negative-electrode radiating fin is held in abutting contact, air inlet windows for drawing air streams to an inside of the rear frame, and air outlet cooling windows for discharging cooling winds, created by the cooling fan, to the outside of the rear frame.

With such a structure, permitting the negative-electrode radiating fin to be mounted on the dike wall formed on the frame allows the dike wall to block the mixing between the inlet air stream and the outlet air streams, thereby ensuring a ventilation flow path as intended on design. In addition, the abutting engagement between the negative-electrode radiating fin and the circumferentially extending dike wall formed on the frame enables the negative-electrode radiating fin to be efficiently cooled with the frame that is cooled with the cooling wind created by the cooling fan. This results in an increase in cooling performance of the rectifying unit.

With the vehicle alternator of the present embodiment, the air inlet windows may be formed in areas radially inward of the dike wall and opened to the substantially and radially same positions as those in which the air inlet openings are formed in the cover.

With such a structure, since the air inlet windows are opened to the substantially and radially same positions as those in which the air inlet openings are formed in the cover, the frame and the cover have lower ventilation resistances as those in which both the air inlet windows and the air inlet openings are formed in radially different positions.

With the vehicle alternator of the present embodiment, the air outlet cooling windows may include first air outlet cooling windows formed in the rear frame at an outer diametric area, and second air outlet cooling windows formed in areas between the dike wall and an outer arc-shaped wall section of the rear frame to allow outlet air winds, passing through the second air outlet cooling windows, to be blown off to the negative-electrode radiating fin and the negative-electrode rectifier element.

With such a structure, since the first and second air outlet cooling windows are formed in the cover, the cooling wind can be blown off to the negative-electrode radiating fin and the negative-electrode rectifier element, providing capability of efficiently cooling the negative-electrode rectifier element.

With the vehicle alternator of the present embodiment, the second air outlet cooling windows may have inward opening portions, respectively, which are placed in face-to-face relation with the cooling fan such that inward peripheral edges are located radially inward from an outer diametric portion of the cooling fan, and outward opening portions, respectively, which are formed in face-to-face relation with the negative-electrode radiating fin and the negative-electrode rectifier element.

With such a structure, the portion of the cooling wind, discharged from the cooling fan, can be efficiently directed to the negative-electrode radiating fin and the negative-electrode rectifier element. This allows the rectifying unit to have increased cooling performance.

With the vehicle alternator of the present embodiment, the second air outlet cooling windows may have stationary blades for deflecting a flow of a portion of an outlet cooling wind created by the cooling fan in an axial direction to guide the flow of the portion of the outlet cooling wind toward the negative-electrode radiating fin and the negative-electrode rectifier element, and wherein the stationary blades may have outward axial end faces placed in face-to-face relation with the negative-electrode radiating fin and the negative-electrode rectifier element.

With the structure mentioned above, no interference occurs between the outlet cooling winds discharged from the second air outlet cooling windows placed adjacent to each other via the stationary blade, thereby preventing the occurrence of turbulent flows. This results in increased cooling performance of the rectifying unit.

With the vehicle alternator of the present embodiment, the frame may include a frame section, circumferentially extending in an area placed away from the dike wall, which has an axial end face axially inward from an axial end face of the dike wall to define a second air inlet opening between the axial end face of the frame section and the negative-electrode radiating fin, and wherein the second air inlet opening communicates with the air inlet window in a position close proximity to the frame section.

With the mere air inlet openings formed in the cover, a risk occurs for the air inlet openings to have a lower total opening surface area than those of the air outlet openings (including the first and second air outlet openings). In contrast, forming the second air inlet openings in areas between the axial end face of the frame section of the frame and the negative-electrode radiating fin in communication with the air inlet windows enables an increase in the total opening surface area of the air inlet openings. This result in an increase in a volume of cooling wind, providing improved cooling performance of the rectifying unit.

Further, since the second air inlet openings are formed between the axial end face of the frame section of the frame and the negative-electrode radiating fin, the air streams, coming through the air inlet openings can efficiently cool the negative-electrode radiating fin.

With the vehicle alternator of the present embodiment, the cover may include an encompassing section that collectively encompasses the positive-electrode rectifier element and an associated neighborhood to prevent the cooling wind drawn to an inside of the cover due to rotation of the cooling fan from directly impinging upon the positive-electrode rectifier element.

With the structure set forth above, none of the positive-electrode rectifier element and the associated neighborhood is directly exposed to the air streams, preventing the corrosion of these component parts due to the influence of salt water mixed to the air streams.

In addition, since the positive-electrode rectifier element and the associated neighborhood are covered with the cover having insulation property, no risk occurs for leakage current to flow through the cover from the positive-electrode radiating fin having a voltage potential. This results in an increase in safety of the vehicle alternator. Also, this provides a compromise between increased cooling performance of the rectifying unit and increased protecting effect of the positive-electrode rectifier element.

With the vehicle alternator of the present embodiment, the frame may have one surface formed with a circumferentially extending dike wall on which the rectifying unit is fixedly mounted, wherein the rectifying unit further comprises a heat conducting sheet sandwiched between the negative-electrode radiating fin and the positive-electrode radiating fin, and wherein the negative-electrode radiating fin may be mounted on the dike wall of the frame in abutting contact therewith and carries the negative-electrode rectifier element such that the negative-electrode radiating fin and the negative-electrode rectifier element face the dike wall of the frame.

With the structure mentioned above, since the rectifying unit is fixedly mounted on the dike wall of the frame, the rectifying unit can have increased cooling performance. In addition, the negative-electrode radiating fin and the positive-electrode radiating fin are stacked on each other by means the heat conducting sheet, the vehicle alternator can have a minimized structure with a shortened axial dimension. Moreover, since the negative-electrode radiating fin is mounted on the dike wall of the frame in abutting contact therewith and carries the negative-electrode rectifier element such that the negative-electrode radiating fin and the negative-electrode rectifier element face the dike wall of the frame, the rectifying unit can have increased cooling performance.

With the vehicle alternator of the present embodiment, the one surface of the frame may include a plurality of radially extending stationary blades radially extending outward from the dike wall to define a plurality of air outlet openings, wherein the stationary blades may have contoured configurations, respectively, to direct a portion of the cooling wind, created by the cooling fan, in an axial direction of the frame to cause the portion of the cooling wind to impinge upon the negative-electrode radiating fin and the negative-electrode rectifier element for cooling.

With such a structure, the presence of the radially extending stationary blades enables the portion of the cooling wind, created by the cooling fan, to be deflected in an axial direction of the frame to cause the portion of the cooling wind to impinge upon the negative-electrode radiating fin and the negative-electrode rectifier element. This results in increased cooling performance of the rectifying unit.

With the vehicle alternator of the present embodiment, the cover may include an encompassing section that collectively covers the positive-electrode radiating fin, the positive-electrode rectifier element and associated wirings in an airtight sealing capability.

With such a structure, since the encompassing section covers the positive-electrode radiating fin and associated wirings, no risk occurs for these component parts to suffer from corrosion resulting from the air streams mixed with salt water. This provides an increase in operating life of the vehicle alternator.

With the vehicle alternator of the present embodiment, the cover may have air inlet windows through which an air stream flows to an inside of the frame upon the rotation of the cooling fan, wherein the positive-electrode radiating fin may have a plurality of protrusions radially extending inward from an inner periphery of the cover to be exposed to the air inlet windows formed in the cover for cooling with the air stream.

With such a structure, since the positive-electrode radiating fin has the protrusions radially extending inward from the inner periphery of the cover, the positive-electrode radiating fin can be exposed to the air streams via the protrusions. This provides an increase in cooling effect of the positive-electrode radiating fin.

Another aspect of the present invention provides a vehicle alternator comprising a stator having at least one armature winding, a rotor having a field winding, a metallic frame supporting the stator and the rotor, at least one rectifying unit mounted on the frame at an outside area thereof and rectifying at least one alternating current voltage induced in the armature winding upon rotation of the rotor, and at least one insulating cover for covering at least one rectifying unit. The rectifying unit comprises a positive-electrode rectifier element, a negative-electrode rectifier element, a positive-electrode radiating fin, on which the positive-electrode rectifier element is mounted, and a negative-electrode radiating fin on which the negative-electrode rectifier element is mounted. The cover includes an encompassing section that collectively encompasses the positive-electrode rectifier element and an associated neighborhood to prevent the cooling wind drawn to an inside of the cover due to rotation of the cooling fan from directly impinging upon the positive-electrode rectifier element.

With the structure set forth above, none of the positive-electrode rectifier element and associated wirings is directly exposed to the air streams. This prevents the positive-electrode rectifier element from corrosion due to adverse affects arising from salt water mixed to the air streams.

Further, since the encompassing section of the cover having insulation property encompasses the positive-electrode rectifier element, no risk occurs for leakage current to flow through the cover from the positive-electrode radiating fin having the voltage potential, contributing to increased safety.

With the vehicle alternator of the present embodiment, the frame may comprise a first frame, facing front sides of the stator and the rotor, and a second frame facing rear sides of the stator and the rotor, wherein the rectifying unit is mounted on at least one of the first and second frames and covered with the cover.

With the structure mentioned above, the present invention may be applied to a vehicle alternator having rectifying units mounted on both sides of the frame. For instance, the present invention can be applied to an alternator of a tandem structure type including one set of armature windings for generating electric power outputs at different voltage levels (such as, for instance 12V and 42V).

With the vehicle alternator of the present embodiment, the cover may have an outer circumferential periphery formed with heat radiating fins.

With such a structure, the presence of the heat radiating fins formed on the cover allows the rectifying unit to have increased cooling effect without causing an increase in the number of component parts of the alternator.

With the vehicle alternator of the present embodiment, the cover may be formed with air inlet openings for drawing air streams to an inside of the cover due to rotation of the cooling fan, and wherein the positive-electrode radiating fin has an inner periphery formed with at least one protrusion radially extending inward and exposed to the air inlet openings.

With such a structure, under a circumstance where a major portion of the positive-electrode radiating fin is covered with the cover, at least one protrusion of the positive-electrode radiating fin can be exposed to the air streams for cooling. This results in an increase in cooling effect of the positive-electrode radiating fin.

With the vehicle alternator of the present embodiment, the air inlet openings may be formed in the cover in radiated configurations, and the cover may include a plurality of radially extending partition walls each of which partitions the air inlet openings which are adjacent to each other in a circumferential direction and each of which is inclined with respect to a center of axis.

With the structure set forth above, the portion of the cooling wind, created by the cooling fan, can be directed in an axial direction of the frame to directly impinge upon the negative-electrode radiating fin and the negative-electrode rectifier element. This results in an increase in cooling effects of the negative-electrode radiating fin and the negative-electrode rectifier element.

### BRIEF DESCRIPTION OF THE DRAWINGS

FIG. 1 is a cross sectional view of a vehicle alternator of an embodiment according to the present invention.

FIG. 2 is a cross sectional view of the vehicle alternator, shown in FIG. 1, showing an operating state for illustrating how air streams and cooling wind flow.

FIG. 3 is a perspective view showing a rear frame forming part of the vehicle alternator shown in FIG. 1.

FIG. 4 is a plan view of the rear frame shown in FIG. 3.

FIG. 5 is a cross sectional view taken on line A-A of FIG. 4.

FIG. 6 is a plan view of a cover forming part of the vehicle alternator shown in FIG.

FIG. 7 is a cross sectional view taken on line B-B of FIG. 6.

FIG. 8 is a cross sectional view of a modified form of the vehicle alternator of the embodiment shown in FIG. 1.

### DETAILED DESCRIPTION OF PREFERRED EMBODIMENTS

Now, vehicle alternators of various embodiments according to the present invention are described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, like reference characters designate like or corresponding parts throughout the several views.

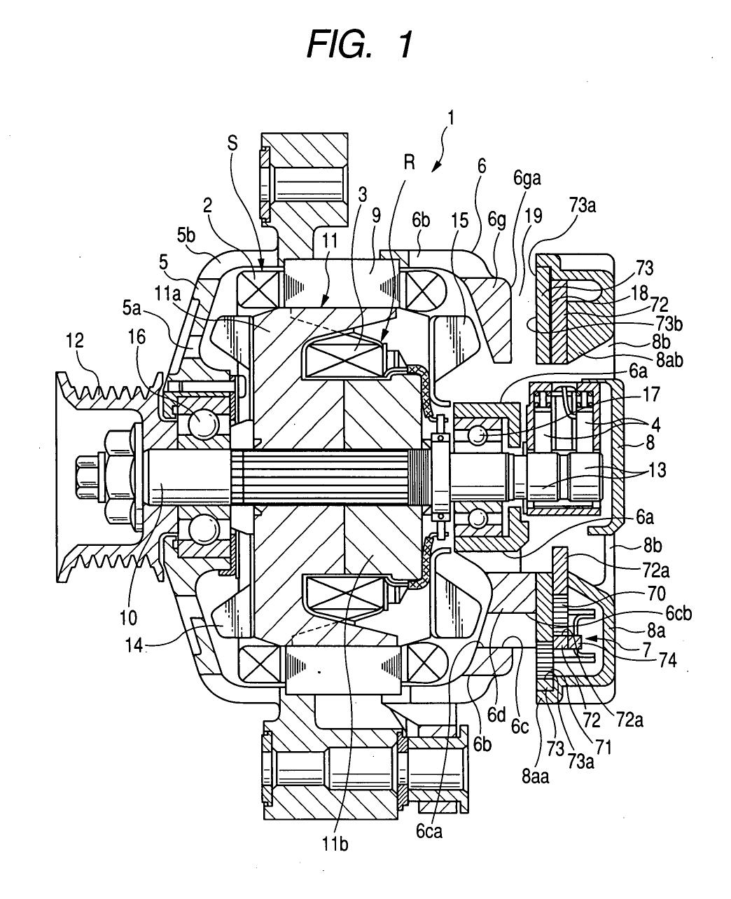

A vehicle alternator of an embodiment according to the present invention is described below in detail with reference to FIG. 1.

As shown in FIG. 1, the vehicle alternator 1 of the present embodiment comprises a stator S having an armature winding 2, a rotor R having a field winding 3, brushes 4 through which field current is supplied to the field winding 3, front and rear frames 5, 6 axially spaced from each other for supporting the stator S and the rotor R, a rectifying unit 7 for rectifying an alternating voltage induced in the armature winding 2, and a cover 8 that covers the rectifying unit 7.

The stator S comprises an armature core 9 having an inner peripheral wall formed with a plurality of circumferentially and equidistantly spaced slots (not shown) and the armature winding 2 wound on the armature core 9 to generate an alternating voltage upon rotation of the rotor R.

The rotor R comprises a field core 11 and the field winding 3 wound on the field core 11. With such a structure, a drive torque of an engine is transferred to the rotary shaft 10, which in turn is rotated.

To this end, the rotary shaft 10 has one end (a left end) on which a pulley 12 is fixed supported. A drive belt (not shown) is tensioned between the pulley 12 and a pulley (not shown) of the engine (not shown) from which drive torque is delivered to the rotary shaft 10. Moreover, the rotary shaft 10 has the other end (a right end) carrying thereon a pair of slip rings 13, to which the field winding 3 is electrically connected.

The field core 11 includes front and rear field cores 11a, 11b that have axially opposite ends to which cooling fans 14, 15 are fixedly secured by welding for unitary rotation with the rotor R.

The brushes 4 are located in areas around outer peripheries of the slip rings 13 in electrical contact therewith. With the rotary shaft 10 rotating, the slip rings 13 slides on the brushes 14 to supply field current to the field coil 13.

The front frame 5 is disposed on a left side of the field core 11a and rotatably carries the one end of the rotary shaft 10 via a front bearing 16. The rear frame 6 is disposed on a right side of the field core 11b and rotatably carries the other end of the rotary shaft 10 via a rear bearing 17. The front and rear frames 11a, 11b sandwich the armature core 9 on axial ends thereof and support the same in a fixed place to allow the front and rear bearings 16, 17 to rotatably support the rotary shaft 10.

The front frame 5 has a front area formed ventilation air inlet windows 5a and a rear area formed with ventilation outlet cooling windows 5b. Likewise, the rear frame 6 has a rear area formed ventilation air inlet windows 6a and outer diametric areas formed with ventilation outlet cooling windows 6b, 6c. The ventilation outlet cooling windows 6b, 6c of the rear frame 6 will be described below in detail.

The rectifying unit 7 includes a plurality of rectifier elements (such as diodes) 70, 71 forming a full-wave rectifier circuit, heat radiating fins 72, 73 formed with mounting bores 72a, 73a, respectively, to which the rectifier elements 70, 71 are press fitted and fixedly mounted, and a terminal block 74 incorporating wiring electrodes of the rectifier elements 70, 71.

The rectifier element 70 plays a role as a positive electrode rectifier that is electrically connected to a positive electrode of an on-vehicle battery (not shown) and the rectifier element 71 plays a role as a negative electrode rectifier that is electrically connected to a negative electrode of the on-vehicle battery.

The heat radiating fin 72 plays a role as a positive-electrode radiating fin and has a bore 72a to which the positive-electrode rectifier element 70 is press fitted and fixedly secured. Likewise, the heat radiating fin 73 plays a role as a negative-electrode radiating fin and has a bore 73a to which the negative-electrode rectifier element 71 is press fitted and fixedly secured. The rectifier elements 70, 71 are made of suitable material such as, for instance, copper having high heat conductivity.

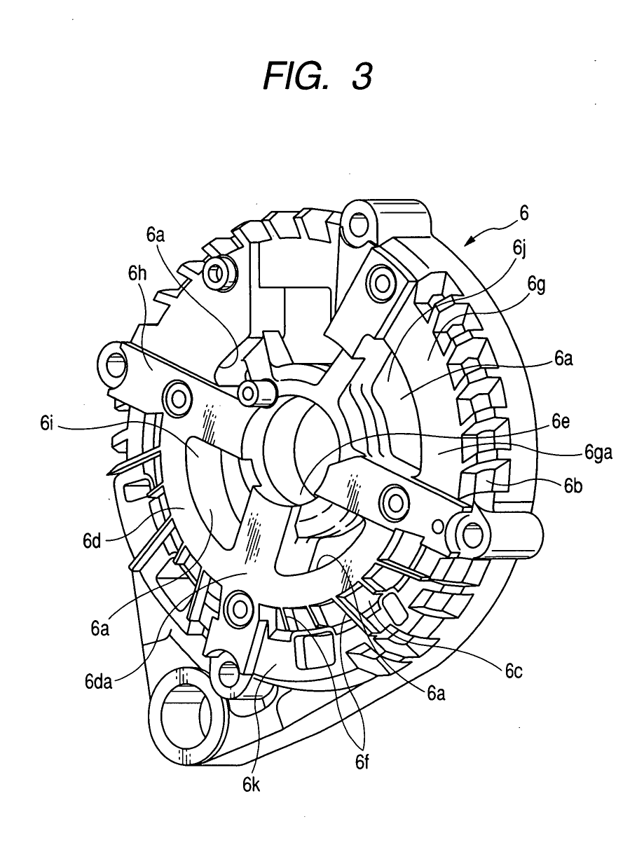

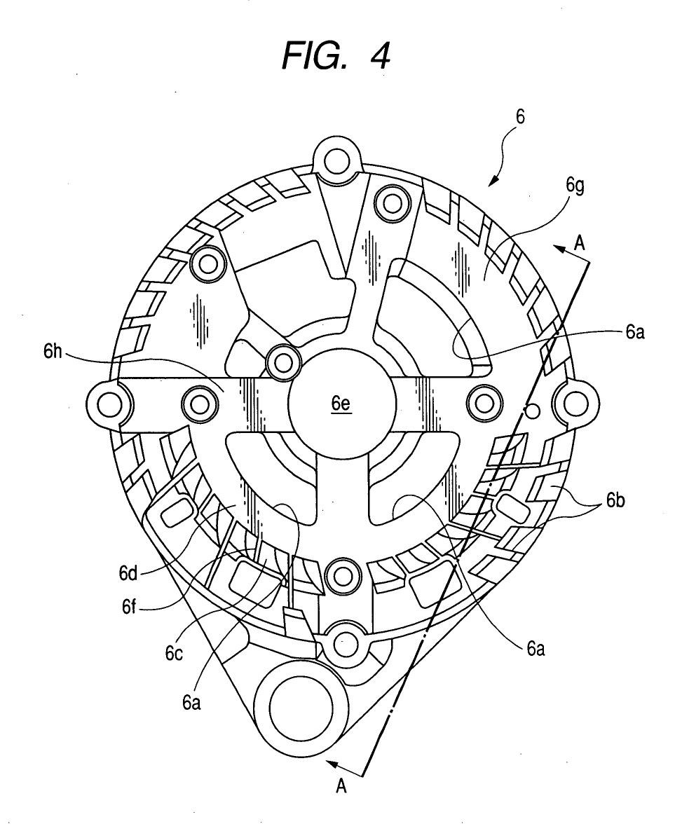

As shown in FIG. 1, the rectifying unit 7 is arranges such that the heat radiating fins 72, 73 are axially stacked on each other via a heat conducting sheet 18 having electrical insulation. With such a structure, the negative-electrode radiating fin 73 is fixedly secured to the rear frame 6 in abutting engagement with an axial end face 6da of a dike wall 6d (see FIGS. 3 and 4) axially protruding from the rear frame 6.

The cover 8 is formed of a resin-molded product formed in a substantially bowl shape and having electrical insulation property and fixedly secured to the rear frame 7 together with the rectifying unit 7 by means of fixture bolts (not shown) so as to cover the various component parts (including the rectifying unit 7 and the brushes 4) located in areas outside the rear frame 6.

The cover 8 includes an encompassing section 8a that collectively covers an area around the positive-electrode rectifier element 70 and the terminal block 74 such that an atmospheric air stream (a cooling wind), drawn from the cooling fan 15, does not directly impinge upon the positive-electrode rectifier element 70. As shown in FIG. 1, the encompassing section 8a has an outer peripheral area 8aa, with which an outer periphery of the negative-electrode radiating fin 73 is held in abutting engagement, and an axially extending semicircular wall 8ab with which the positive-electrode radiating fin 72 is held in abutting engagement to maintain the positive-electrode rectifier element 70 and associated surroundings in a substantially and hermetically sealed state. In addition, a heat conductive sheet (such as a heat conducting sheet) with high heat conductivity may be intervened between the semicircular wall 8ab of the cover 8 and the positive-electrode rectifier element 70.

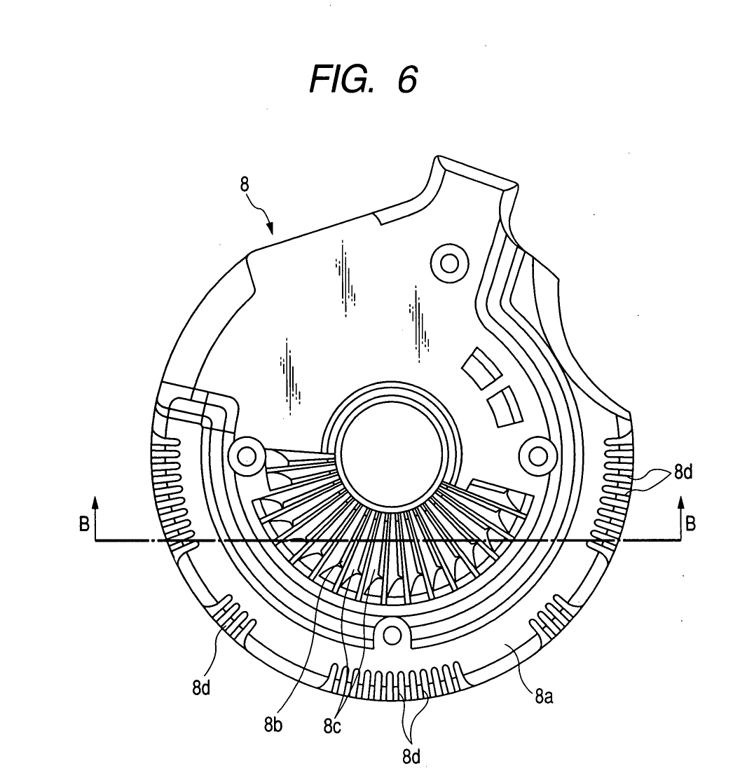

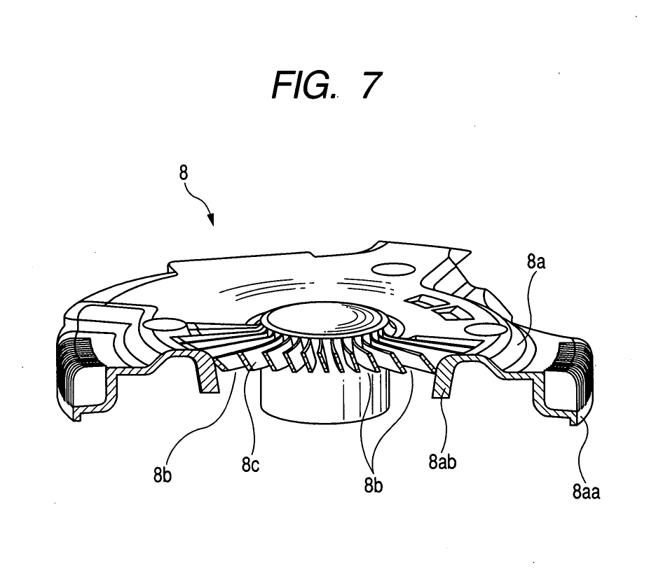

The semicircular wall 8ab of the cover 8 is formed with air inlet openings 8b that are opened at a rear end face of the cover 8 for drawing air streams to an inside of the cover 8 during rotation of the cooling fan 15. As best shown in FIG. 6, the air inlet openings 8b are formed in the cover 8 along a radial direction thereof and, as shown in FIG. 7, the semicircular wall 8ab of the cover 8 surrounds a plurality of radially extending partition walls 8c that are inclined with respect to a central axis of the alternator 1.

Further, the positive-electrode radiating fin 72 has a semicircular. Inner periphery formed with a plurality of inwardly and radially extending protruding segments 72a that protrude radially inward from an inner periphery of the semicircular wall 8ab of the cover 8 into the air inlet openings 8b.

In addition, as shown in FIG. 6, the cover 8 has an outer diametric section formed with a plurality of groups of radially extending radiating fins 8d.

Next, a structure of the rear frame 6 is described below in detail.

As shown in FIGS. 3 and 4, the rear frame 6 has a rear wall formed with a radially extending bridge 6h radially extending across a center of the rear frame 6. The rear frame 6 has a radially central area, formed with a round bore 6e through which the other end of the rotary shaft 10 extends, and a substantially radially middle area formed with the dike wall 6d that straddles the radially extending bridge 6h of the rear frame 6 in a semicircular arc configuration.

In addition, the rear frame 6 has the air inlet openings 6a which are formed in circular arc shapes, respectively, to intake the air streams into the inside of the rear frame 6. Moreover, the rear frame 6 has an outer peripheral area formed with the air outlet cooling windows 6b, 6c, arranged in semicircular arc configurations, respectively, for discharging the cooling wind (hereinafter referred to as an outlet cooling wind), forced by the cooling fan 15, to an outside of the rear frame 6.

The dike wall 6d is formed in the substantially radially middle area of the rear surface of the rear frame 6 and has an axially facing end face 6da to which the negative-electrode radiating fin 73 is fixedly held in abutting engagement in a manner as shown in FIG. 1.

The air inlet windows 6a are formed in annular areas located radially inward of the dike wall 6d in a substantially and radially alignment with the air inlet openings 8b formed in the cover 8. The rear frame 6 has not only a first semicircular area 6i in which the semicircular dike wall 6d is formed and the air inlet windows 6a are formed in a segmented area radially inward of the dike wall 6d but also a second semicircular area 6j in which the air inlet windows 6a are formed in segmented areas at positions where the dike wall 6d is not formed.

The air outlet cooling windows 6b, 6c include first air outlet cooling windows 6b, arrayed in a semicircular area of the rear frame 6 on an outer diametric region thereof, and second air outlet cooling windows 6c arrayed in another semicircular area between the first air outlet cooling windows 6b and the dike wall 6d.

The first air outlet cooling windows 6b include a plurality of openings, formed in an annular circumferential area throughout an entire circumference of the rear frame 6, through which, among outlet cooling winds discharged from the cooling fan 15, those of the cooling winds primarily impinged upon the armature winding 2 are discharged to the outside of the rear frame 6.

The second air outlet cooling windows 6c include a plurality of openings formed in circumferentially arc-shaped areas around the dike wall 6d to allow a portion of an outlet cooling wind, created by the cooling fan 15, to impinge upon the negative-electrode radiating fin 73 and the negative-electrode rectifier element 71 after which the outlet cooling wind is discharged to the outside of the rear frame 6.

As shown in FIG. 1, the second air outlet cooling windows 6c have inward opening portions 6ca formed in face-to-face relation with the cooling fan 15 and opening inward, with inward circumferential edges of the inward opening portions being located in positions radially inward of an outer diametric portion of the cooling fan 15. In addition, the second air outlet cooling windows 6c have outward opening portions 6cb, exposed to the outside of the rear frame 6, which are formed in face-to-face relation with the negative-electrode radiating fin 73 and the negative-electrode rectifier element 71 to cause the outlet cooling wind to impinge upon these component elements for cooling.

Further, the second air outlet cooling windows 6c are defined with stationary blades 6f, respectively, which radially extend outward from an outer periphery of the dike wall 6d toward an outer arc-shaped wall section 6k of the rear frame 6 to guide a portion of the outlet cooling wind coming from the cooling fan 15 to the negative-electrode radiating fin 73 and the negative-electrode rectifier element 71.

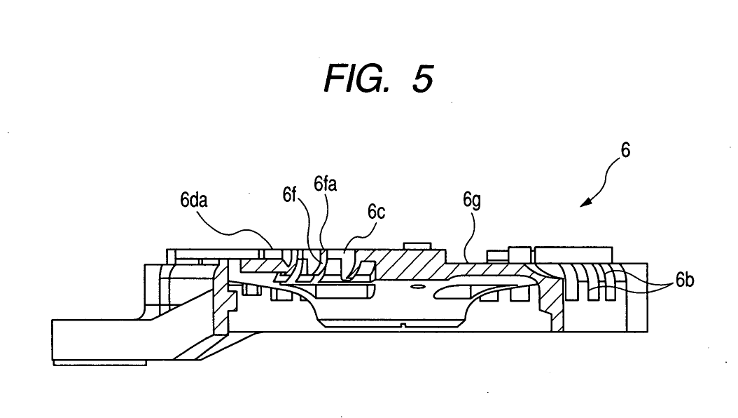

The stationary blades 6f serve as partition walls that partition the neighboring second air outlet cooling windows from each other. As best shown in FIG. 5, the stationary blades 6f radially extend from the outer arc-shaped wall section 6k to the dike wall 6d in gradually curved shapes and have axial end faces 6fa axially aligned on the same height as an axial end face 6da of the dike wall 6d.

In addition, the rear frame 6 further comprises an arc-shaped frame section 6g that circumferentially extends in an area between the air inlet window 6a and the air outlet cooling windows 6b. The arc-shaped frame section 6g has an axial end face 6ga axially spaced inward of the axial end face 6da of the dike wall 6d to define second air inlet openings 19 (see FIG. 1) in areas between the axial end face 6ga of the arc-shaped frame section 6g and the negative-electrode radiating fin 73 in communication with the air inlet windows 6a.

Next, the operation and advantages effects of the vehicle alternator 1 of the present is embodiment are described below in detail.

First, description is made of a flow of a cooling wind created upon rotation of the cooling fan 15.

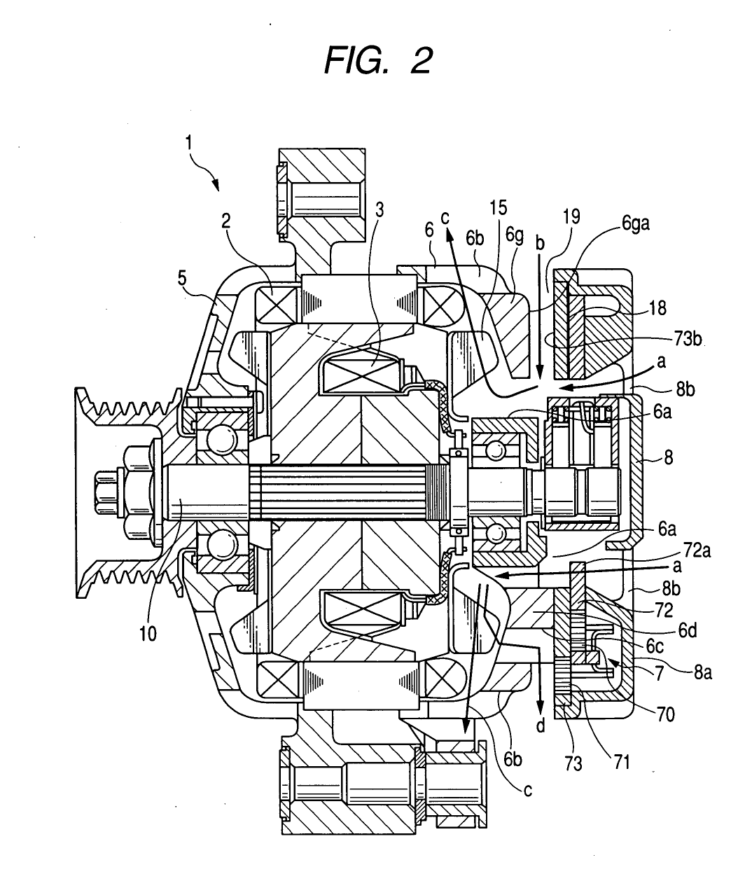

In operation, the cooling fan 15 rotates with the rotor R in a unitary fashion. At this moment, the cooling fan 15 creates a centrifugal force. This causes air streams to occur and flow through the air inlet openings 8b in a direction as shown by an arrow “a” in FIG. 2 and air streams to flow through the second air inlet openings 19, defined between the axial end face 6ga of the arc-shaped frame section 6g and the inner end face 73a of the. negative-electrode radiating fin 73, in a direction as shown by an arrow “b” in FIG. 2.

The air streams, passing through the air inlet openings 8b and the second air inlet openings 19, then flow through the air inlet windows 6a into an inward area of the rear frame 6. These air streams become a swirling flow due to the action of the cooling fan 15 and are caused to flow radially outward as outlet cooling winds. These cooling winds flow through the first air outlet openings 6b and the second air outlet openings 6c in directions as shown by arrows “c” and “d” in FIG. 2, respectively.

With the vehicle alternator 1 of the present embodiment, the positive-electrode radiating fin 72 and the negative-electrode radiating fin 73 of the rectifying unit 7 is stacked on each other via the head conducting sheet 18. This allows heat to be conducted between the positive-electrode radiating fin 72 and the negative-electrode radiating fin 73, enabling the rectifying unit 7 to be cooled under a uniformalized temperature distribution.

In addition, since the negative-electrode radiating fin 73 of the rectifying unit 7 is fixedly mounted on the dike wall 6d of the rear frame 6 in contact therewith and the positive-electrode radiating fin 72 is held in direct contact with the cover 8, heat developed in the rectifying unit 7 can be dissipated to both of the rear frame 6 and the cover 8. Thus, heat can be radiated from the rear frame 6 and the cover 8, providing improved cooling effects.

In particular, since the cover 8 is formed with the heat radiating fins 8d, the cover 8 can radiate heat to the atmosphere in a highly efficient manner.

The positive-electrode radiating fin 72 has the inwardly protruding segments 72a protruding radially inward from the inner peripheral edge of the encompassing section 8a formed in the cover 8 into a radial position where the air inlet openings 8b are formed. Such a structure enables not only heat to be transferred to the rear frame 6 and the cover 8 but also air streams, drawn through the air inlet openings 8b, to impinge upon the inwardly protruding segments 72a of the positive-electrode radiating fin 72 for thereby cooling the same in an efficient manner.

Further, the cover 8 is formed with the plurality of inclined partition walls 8c each of which partitions the circumferentially neighboring air inlet openings 8b from each other. Such a structure results in effect of suppressing the entry of foreign matters through the air inlet openings 8b and an increase in surface areas of the partition walls 8c with increased cooling effects of the radiating fins being expected.

The rear frame 6 has the air inlet windows 6a for drawing a cooling wind and the air inlet windows 6a is opened at the substantially same position as the radial position of the air inlet openings 8b formed in the cover 8. Such a structural arrangement enables cooling winds, drawn from the air inlet openings 8b of the cover 8, to pass through the air inlet windows 6a of the rear frame 6 intact without causing remarkable deflection in path of such cooling winds.

That is, such a structural arrangement can obtain a lower ventilation resistance than that of a case wherein the air inlet openings 8b and the air inlet windows 6a are formed in radially offset positions. Thus, a combination between the rear frame 6 and the cover 8 results in the capability of drawing cooling winds in highly efficient fashion.

Further, the rear frame 6 has the second air outlet cooling windows 6c, formed in the arc-shaped area radially outward of the dike wall 6d, through which outlet cooling winds are discharged so as to impinge upon the negative-electrode radiating fins 73 and the negative-electrode rectifier element 71 upon which the outlet cooling winds are discharged to the outside of the rear frame 6.

That is, the second air outlet cooling windows 6c have the inward opening portions 6ca opened to the inside of the rear frame 6 at the positions in face-to-face relation with the cooling fan 15 with the radially inward edges of the inward opening portions 6ca being located in the areas radially inward of the outer diametric portion of the cooling fan 15.

In addition, the second air outlet cooling windows 6c have the outward opening portions 6cb formed in face-to-face relation with the negative-electrode radiating fins 73 and the negative-electrode rectifier element 71. Such a structural arrangement enables a portion of the outlet cooling wind coming from the cooling fan 15 to pass through the second air outlet cooling windows 6c upon which the portion of the outlet cooling wind to be brown off to the negative-electrode radiating fins 73 and the negative-electrode rectifier element 71 in an efficient manner with increased cooling effect.

Furthermore, the second air outlet cooling windows 6c have the stationary blades 6f, radially extending toward the axis of the rear frame 6 in gradually curved configurations, with which a portion of the outlet cooling wind coming from the cooling fan 15 is guided and deflected in an axial direction so as to axially impinge upon the negative-electrode radiating fins 73 and the negative-electrode rectifier element 71.

With such a structure, the stationary blades 6f scoop a portion of a swirling wind (outlet cooling wind) discharged in a radial direction by the action of the cooling fan 15, deflecting the flow of the portion of the swirling wind flows in an axial direction at a gradual rating. This causes the portion of the swirling wind to be blown off to the negative-electrode radiating fins 73 and the negative-electrode rectifier element 71 at angles closer to a substantially right angle with respect to these components. This results in the capability of effectively utilizing the outlet cooling wind, passing through the second air outlet cooling windows 6c, to provide an increased cooling effect.

Moreover, since the axial end faces 6fa of the stationary blades 6f are formed to have the same axial height as the axial end face 6da of the dike wall 6d, the axial end faces 6fa of the stationary blades 6f can be held in direct contact with the axial end face 73a of the negative-electrode radiating fin 73 without causing the formation of a clearance between the stationary blades 6f and the axial end face 73a of the negative-electrode radiating fin 73.

In such a case, no interference occurs between the outlet cooling winds coming from the neighboring second air outlet cooling windows 6c via the stationary blades 6f with no formation of turbulent flows. This enables the outlet cooling winds coming from the neighboring second air outlet cooling windows 6c to cool the negative-electrode radiating fins 73 and the negative-electrode rectifier element 71 increasing the cooling effect.

In addition, the structural arrangement in which the negative-electrode radiating fins 73 is held in abutting contact with the axial end face 6e of the dike wall 6d enables the dike wall 6d to block the mixing between intake air and outlet air. This results in the capability of ensuring reliable ventilation paths as intended on design.

With the vehicle alternator 1 of the present embodiment, the second air inlet openings 19 are formed between the axial end face 6ga of the frame section 6g of the rear frame 6 and the axial end face 73a of the negative-electrode radiating fins 73 are formed. This allows atmospheric air to be drawn not only through the air inlet openings 8b, formed in the cover 8, but also through the second air inlet openings 19.

This results in an increase in the flow rate of the cooling wind, providing an increased cooling effect.

That is, the mere presence of the air inlet openings 8b formed in the cover 8 results in a limited space for the air inlet openings 8b to be formed and a difficulty is encountered in ensuring a total opening surface area of the air inlet openings 8b at an adequate rate in contrast to a total opening surface area of the air outlet cooling windows (such as the first air outlet cooling windows 6b and the second air outlet cooling windows 6c).

On the contrary, utilizing the area of the rear frame 6 with no formation of the dike wall 6d allows the formation of the second air inlet openings 19. This results in an increase in a total opening surface area combined with the air inlet openings 8b and the second air inlet openings 19, enabling an increase in a volume of a cooling wind with increased cooling effect.

In addition, since the second air inlet openings 19 are formed in an area between the axial end face 6ga of the frame section 6g and the axial end face 73a of the negative-electrode radiating fins 73, the cooling winds drawn through the second air inlet openings 19 can cool the negative-electrode radiating fins 73 in an efficient fashion.

With the vehicle alternator 1 of the present embodiment, the encompassing section 8a of the cover 8 encompasses the positive-electrode rectifier element 70 and associated neighborhoods in a substantially airtight relationship. Thus, no probability takes place for atmospheric air (cooling wind), drawn into the inside of the rear frame 6 due to the action of the cooling fan 15, to directly impinge upon the positive-electrode rectifier element 71 and the terminal box 74. This prevents the occurrence of corrosion of the positive-electrode rectifier element 70 and associated wirings without causing any salt water mixed in a cooling wind from adversely affecting the positive-electrode rectifier element 71 and the terminal box 74.

Further, since the cover 8, encompassing the positive-electrode rectifier element 70, is made of synthetic resin with electrical insulation, there is no fear of an electric current leaking through the cover 8 from the positive-electrode radiating fin 72 with a voltage potential, providing contribution to increased safety. This provides a compromise between the improvement in cooling effect for the rectifying unit 7 and the protection of the positive-electrode rectifier element 70.

With the vehicle alternator 1 of the present embodiment, furthermore, since the positive-electrode radiating fin 72 of the rectifying unit 7 and the negative-electrode radiating fin 73 are held in abutting contact with each other via the heat conducting sheet 18, the vehicle alternator 1 can have a reduced axial length in a minimized structure in contrast to the structure of the related art alternator in which a ventilation path is formed between the radiating fins 72 and 73.

(Modified Form)

Although the vehicle alternator 1 of the present embodiment has been described with reference to a structure wherein the rectifying unit 7 is mounted on the rear frame 6 at an outside area thereof, the present invention is not limited to such a structure. The present invention may be applied to an alternator formed in a tandem structure including one set of armature windings 2 arranged to generate output voltages at different voltage levels such as, for instance, 12V and 42V.

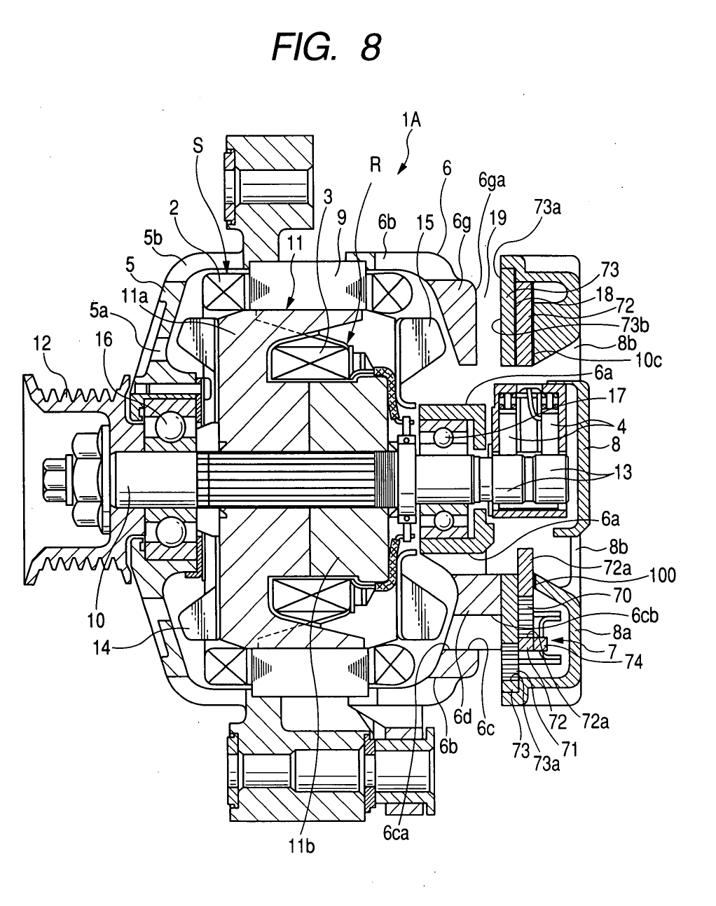

Moreover, although the vehicle alternator 1 of the present embodiment has been described with reference to a structure wherein the encompassing section 8a of the cover 8 is held in direct contact with a rear surface of the positive-electrode radiating fin 72, a vehicle alternator 1A may take the form of another structure as shown in FIG. 8.

That is, the encompassing section 8a of the cover 8 may be held in direct contact with the rear surface of the positive-electrode radiating fin 72 via a heat conducting sheet 100 as shown in FIG. 8.

While the specific embodiments of the present invention have been described in detail, it will be appreciated by those skilled in the art that various modifications and alternatives to those details could be developed in light of the overall teachings of the disclosure. For instance, the material of the seal member includes not only fluorocarbon rubber but also other material, having heat resistance, such as silicone rubber or the like. Moreover, measuring gas may include not only oxygen gas but also other gas components such as NOx, CO, HC or the like. The gas sensor element may include any of structures including a stack type and a cup type.

What is claimed is:

1. A vehicle alternator comprising:
a stator having an armature winding;
a rotor having a field winding;
a metallic frame supporting the stator and the rotor;
a rectifying unit, placed on the frame at an outside area thereof and rectifying an alternating current voltage induced in the armature winding upon rotation of the rotor, which comprises a positive-electrode rectifier element, a negative-electrode rectifier element, a positive-electrode radiating fin, carrying thereon the positive-electrode rectifier element, and a negative-electrode radiating fin carrying thereon the negative-electrode rectifier element; and
an insulating cover with which the rectifying unit is covered;
wherein the negative-electrode radiating fin and the positive-electrode radiating fin are axially placed adjacent to each other between the rear frame and the cover.

2. The vehicle alternator according to claim 1, wherein:
the negative-electrode radiating fin and the positive-electrode radiating fin are
stacked on each other via a heat conducting sheet having insulation property.

3. The vehicle alternator according to claim 1, wherein:
the negative-electrode radiating fin is fixedly secured to the frame in contact therewith.

4. The vehicle alternator according to claim 1, wherein:
the positive-electrode radiating fin is held in direct contact with the cover.

5. The vehicle alternator according to claim 1, wherein:
the cover is held in contact with the positive-electrode radiating fin via a heat conducting sheet having high heat conductivity.

6. The vehicle alternator according to claim 1, wherein:
the cover has an outer circumferential periphery formed with heat radiating fins.

7. The vehicle alternator according to claim 1, wherein:
the cover is formed with air inlet openings for drawing air streams to an inside of the cover due to rotation of the cooling fan; and
wherein the positive-electrode radiating fin has an inner periphery formed with at least one protrusion radially extending inward and exposed to the air inlet openings.

8. The vehicle alternator according to claim 7, wherein:
the air inlet openings are formed in the cover in radiated configurations; and
the cover includes a plurality of radially extending partition walls each of which partitions the air inlet openings which are adjacent to each other in a circumferential direction and each of which is inclined with respect to a center of axis.

9. The vehicle alternator according to claim 1, wherein:
the frame includes a circumferentially extending dike wall, having an axial end face with which the negative-electrode radiating fin is held in abutting contact, air inlet windows for drawing air streams to an inside of the rear frame, and air outlet cooling windows for discharging cooling winds, created by the cooling fan, to the outside of the rear frame.

10. The vehicle alternator according to claim 9, wherein:
the air inlet windows are formed in areas radially inward of the dike wall and opened to the substantially and radially same positions as those in which the air inlet openings are formed in the cover.

11. The vehicle alternator according to claim 9, wherein:
the air outlet cooling windows include first air outlet cooling windows formed in the rear frame at an outer diametric area, and second air outlet cooling windows formed in areas between the dike wall and an outer arc-shaped wall section of the rear frame to allow outlet air winds, passing through the second air outlet cooling windows, to be blown off to the negative-electrode radiating fin and the negative-electrode rectifier element.

12. The vehicle alternator according to claim 11, wherein:
the second air outlet cooling windows have inward opening portions, respectively, which are placed in face-to-face relation with the cooling fan such that inward peripheral edges are located radially inward from an outer diametric portion of the cooling fan, and outward opening portions, respectively, which are formed in face-to-face relation with the negative-electrode radiating fin and the negative-electrode rectifier element.

13. The vehicle alternator according to claim 12, wherein:
the second air outlet cooling windows have stationary blades for deflecting a flow of a portion of an outlet cooling wind created by the cooling fan in an axial direction to guide the flow of the portion of the outlet cooling wind toward the negative-electrode radiating fin and the negative-electrode rectifier element; and
wherein the stationary blades have outward axial end faces placed in face-to-face relation with the negative-electrode radiating fin and the negative-electrode rectifier element.

14. The vehicle alternator according to claim 9, wherein:
the frame includes a frame section, circumferentially extending in an area placed away from the dike wall, which has an axial end face axially inward from an axial end face of the dike wall to define a second air inlet opening between the axial end face of the frame section and the negative-electrode radiating fin; and
wherein the second air inlet opening communicates with the air inlet window in a position close proximity to the frame section.

15. The vehicle alternator according to claim 1, wherein:
the cover includes an encompassing section that collectively encompasses the positive-electrode rectifier element and an associated neighborhood to prevent the cooling wind drawn to an inside of the cover due to rotation of the cooling fan from directly impinging upon the positive-electrode rectifier element.

16. The vehicle alternator according to claim 1, wherein:
the frame has one surface formed with a circumferentially extending dike wall on which the rectifying unit is fixedly mounted;
wherein the rectifying unit further comprises a heat conducting sheet sandwiched between the negative-electrode radiating fin and the positive-electrode radiating fin; and
wherein the negative-electrode radiating fin is mounted on the dike wall of the frame in abutting contact therewith and carries the negative-electrode rectifier element such that the negative-electrode radiating fin and the negative-electrode rectifier element face the dike wall of the frame.

17. The vehicle alternator according to claim 16, wherein:
the one surface of the frame includes a plurality of radially extending stationary blades radially extending outward from the dike wall to define a plurality of air outlet openings;
wherein the stationary blades have contoured configurations, respectively, to direct a portion of the cooling wind, created by the cooling fan, in an axial direction of the frame to cause the portion of the cooling wind to impinge upon the negative-electrode radiating fin and the negative-electrode rectifier element for cooling.

18. The vehicle alternator according to claim 17, wherein:
the cover includes an encompassing section that collectively covers the positive-electrode radiating fin, the positive-electrode rectifier element and associated wirings in an airtight sealing capability.

19. The vehicle alternator according to claim 18, wherein:
the cover has air inlet windows through which an air stream flows to an inside of the frame upon the rotation of the cooling fan;
the positive-electrode radiating fin has a plurality of protrusions radially extending inward from an inner periphery of the cover to be exposed to the air inlet windows formed in the cover for cooling with the air stream.

20. A vehicle alternator comprising:
a stator having at least one armature winding;
a rotor having a field winding;
a metallic frame supporting the stator and the rotor;
at least one rectifying unit mounted on the frame at an outside area thereof and rectifying at least one alternating current voltage induced in the aimature winding upon rotation of the rotor; and
at least one insulating cover for covering the at least one rectifying unit;
wherein the rectifying unit comprises a positive-,electrode rectifier element, a negative-electrode rectifier element, a positive-electrode radiating fin, on which the positive-electrode rectifier element is mounted, and a negative-electrode radiating fin on which the negative-electrode rectifier element is mounted; and
wherein the cover includes an encompassing section that collectively encompasses the positive-electrode rectifier element and an associated neighborhood to prevent the cooling wind drawn to an inside of the cover due to rotation of the cooling fan from directly impinging upon the positive-electrode rectifier element.

21. The vehicle alternator according, to claim 20, wherein:
the frame comprises a first frame, facing one sides of the stator and the rotor, and a second frame facing the other sides of the stator and the rotor; and
wherein the rectifying unit is mounted on at least one of the first and second frames and covered with the cover.

22. The vehicle alternator according to claim 20, wherein: the cover has an outer circumferential periphery formed with heat radiating fins.

23. The vehicle alternator according to claim 20, wherein:
the cover is formed with air inlet openings for drawing air streams to an inside of the cover due to rotation of the cooling fan; and
wherein the positive-electrode radiating fin has an inner periphery formed with at least one protrusion radially extending inward and exposed to the air inlet openings.

24. The vehicle alternator according to claim 23, wherein:
the air inlet openings are formed in the cover in radiated configurations; and
the cover includes a plurality of radially extending partition walls each of which partitions the air inlet openings which are adjacent to each other in a circumferential direction and each of which is inclined with respect to a center of axis.
